(19) United States
(12) Patent Application Publication
(10) Pub. No.: US 2019/0259043 A1
(43) Pub. Date: Aug. 22, 2019

(54) METHOD AND SYSTEM FOR SUPPLY CHAIN MANAGEMENT

(71) Applicant: Target Brands, Inc., Minneapolis, MN (US)

(72) Inventors: ABHILASH KONERI, Minneapolis, MN (US); VENKATA PUTREVU, Minneapolis, MN (US); MARCUS MANLEY, Minneapolis, MN (US); ARCHANA RUPJI, Minneapolis, MN (US)

(21) Appl. No.: 15/898,837

(22) Filed: Feb. 19, 2018

(51) Int. Cl. G06Q 30/02; G06Q 10/08; G06N 7/00

(52) U.S. Cl. CPC G06Q 30/0202; G06F 17/30002; G06N 7/005; G06Q 10/087

(57) ABSTRACT

Methods and systems for managing supply chains are disclosed. Replenishment of items within retail stores and distribution centers is optimized to respond to real-time demands. One method includes determining optimized inventory positions based on demand probability distributions. Items are stocked at locations within a supply chain in order to support efficient movement of items to customers. Inventory levels are maintains in real time. Proactive and reactive demand signals are received and are processed to trigger movements of items within the supply chain to fill orders and replenish stocks in anticipation of future customer demand.

### TECHNICAL FIELD

The present disclosure relates generally to methods and systems for managing supply chains. More particularly, the present disclosure describes a system architecture for managing the inventory and transportation of items within a retail organization.

### BACKGROUND

Management of retail supply chains has progressively become more automated with the use of computerized systems for monitoring and controlling movements of inventory. Online sales have provided an additional revenue stream for many traditional brick-and-mortar retailers, but have also created more complications in the management of inventory. In order to simplify the process of filling orders, online orders are typically handled separately from in-store sales. Separate SKUs are used even if the exact same product is being sold both online and in stores. While this may simplify the process of filling orders, it produces inefficiencies in product availability. A customer may want to buy a product online, but the system informs the customer that the product is sold out. However, the exact same product is available in a store, but with a different SKU. The retailer has thus missed out on a sale because its stock of inventory is separated into online and in-store SKUs.

Inventory for both in-store and online sales is typically transported and stored in large groupings such as pallets. Often, inventory sits too long in some storage locations while in other locations the products run out much too quickly. For locations where a product has a small but steady demand, it is inefficient to ship large quantities of the product to those locations at a time because most of the stock will go unused for a long period of time. By shipping a large amount to those locations at once, warehouses have to house inventory this is not needed immediately while other warehouses or stores might be short on that particular product.

Existing retail supply chain architectures require large amounts of additional stock to sit in warehouses and store rooms in order to meet customer demands for products. Storing inventory is costly, and if the inventory is not positioned well within the supply chain, delivery timeframes to customers can be lengthy. If customer demand can be predicted and the appropriate amount of product is available near the customer, less storage space is required without losing out on sales.

### SUMMARY

In summary, the present disclosure relates to methods and systems for managing replenishment of inventory in a retail supply chain. Various aspects are described in this disclosure, which include, but are not limited to, the following aspects.

In one aspect, a method of managing inventory replenishment in an enterprise supply chain is provided where the enterprise supply chain includes a plurality of retail locations and a plurality of distribution locations. Optimized inventory positions are determined for each of a plurality of items at each of the retail and distribution locations. Optimized inventory positions are determined by a demand probability distribution for the plurality of items. Inventory positions are then monitored at each of the locations. Demand signals are received from a point of sale system in communication with the plurality of retail locations as well as an online ordering system. Demand signals come in the form of sales made at stores or online. In response to the demand signals, inventory is replenished to achieve the optimized inventory positions for the items. Replenishment occurs by first determining, based on monitoring the inventory levels, which retail locations and distribution locations have inventory deficits and which have inventory surpluses. Transfer orders are generated and sent to distribution locations having surplus inventory or purchase orders are sent to vendors. Transportation is then arranged to take inventory from the vendor or distribution location having surplus inventory to the retail locations and distribution locations having deficits. Once the transfers are complete, the new inventory positions of each item in each location is recorded in an inventory data store.

In another aspect, a system for managing supply chain operations in an enterprise including a plurality of retail locations and a plurality of distribution locations is described. The system includes a replenishment management system and an inventory management system. Both the replenishment management system and the inventory management system include computing systems that include a processor communicatively coupled to a memory. The memory of the replenishment management system stores instructions executable by the processor to receive demand signals from one or more online ordering systems, point of sale systems, and/or demand forecast engines. The system then determines how much inventory to allocate to each of the retail locations and distribution locations within the supply chain. Inventory requests are generated to replenish inventory at the locations. The memory of the inventory management system stores instructions that, when executed by the processor, receive inventory requests from the replenishment management system. The inventory management system also monitors inventory levels at each of the retail locations and distribution locations. In response to inventory requests, purchase orders and transfers orders are generated.

In yet another aspect, a non-transitory computer-readable storage medium comprising computer-executable instructions is disclosed which, when executed by a computing system, cause the computing system to perform a method of managing inventory replenishment. Optimized inventory positions are determined for each of a plurality of items at each of the retail locations and distribution locations within a supply chain. The inventory positions are determined based on at least one of a demand probability distribution for the plurality of items, balancing direct costs with opportunity costs, and customer availability goals. Inventory positions of the items at each of the retail and distribution locations are monitored. Demand signals in the form of sales are received from a point of sale system in communication with the plurality of retail locations and an online ordering system. In response to the demand signals, inventory is replenished to achieve the optimized inventory positions for the plurality of items. Replenishment involves determining which retail locations and distribution locations have an inventory deficient and which have an inventory surplus. Transfer orders are generated to distribution locations having surplus inventory and/or purchase orders are sent to vendors. Transportation is arranged to move inventory from the vendor or distribution location having surplus inventory to the retail locations and distribution locations having deficits. The new inventory positions of each item in each location are then recorded in an inventory data store.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

FIG. 1 illustrates a schematic diagram of an example supply chain for a retail enterprise.

FIG. 2 illustrates a schematic diagram of an example supply chain management system.

FIG. 3 illustrates a more detailed view of the replenishment management system and inventory management system of FIG. 2.

FIG. 4 illustrates an example block diagram of a computing system usable in the supply chain management system of FIG. 2.

FIG. 5 is a flow chart of an example method of managing inventory replenishment in a retail supply chain.

FIG. 6 is flow chart of an example method of determining optimized inventory positions for items within a supply chain.

FIG. 7 is a flow chart of an example method of replenishing inventory to achieve optimized inventory positions.

FIG. 8 is a flow chart of an example method of arranging transportation of inventory.

FIG. 9 is a histogram of an example demand probability distribution.

FIG. 10 is an example graph of demand distributions for two different items.

FIG. 11 is a graph illustrating the replenishment process of a new item according to the method of FIGS. 5-8 as performed by the system of FIGS. 2-3 in a retail store.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

In general, the present disclosure relates to methods and systems for managing inventory within a supply chain. In particular, the supply chain is for a collection of retail stores, but also supports product fulfillment via an affiliated online ordering system. The supply chain management system operates to monitor and manage inventory levels in a plurality of nodes throughout the enterprise. Nodes can include retail stores and warehouses. Warehouses serve to store inventory and also function as distribution centers. The distribution centers can have particular purposes such as a receive center for receiving products from vendors and preparing them for distribution to other nodes, or a flow center for holding inventory stock for distribution to retail stores and individual customers. The supply chain management system determines how much inventory to hold at each node and manages transfers of inventory in order to achieve the preferred amounts of inventory at each node. The movements of inventory can be based on expected demand as well as reactions to actual demand from customers.

The methods and systems described herein provide an event-driven architecture for real-time replenishment of inventory, tracked on a per-item basis. The system is both proactive and reactive. Demand forecasting is utilized to anticipate customer demand at each location for each item. In addition, the system reacts to each individual sale to replenish stocks as needed based on actual demand. The same stocks of inventory are utilized to fulfill needs for both in-store and online sales. Inventory stocks are continually rebalanced throughout the supply chain in order to position items in locations where they are mostly likely to be needed in order to reduce shipping time and storage time. The methods and systems described herein provide efficiencies in supply chain management that unexpectedly allow for both a reduction in the amount of inventory that is stored at any time, both throughout an enterprise and at retail locations in particular, while also being able to reliably respond more quickly to customer demand.

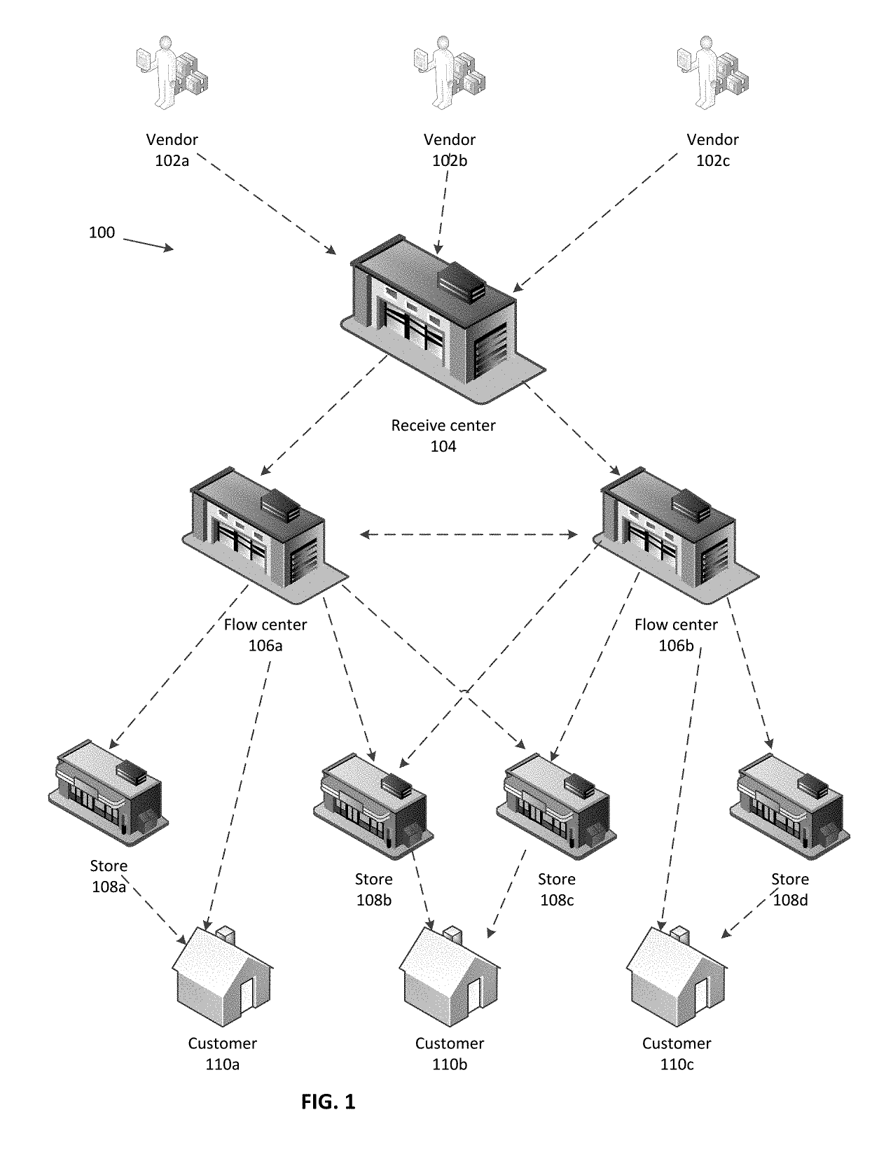

FIG. 1 illustrates a schematic diagram 100 of an example supply chain for a retail enterprise. The diagram 100 illustrates the flow of inventory from vendor 102 to customer 110. The inventory moves through various nodes to arrive at the customer. In this example, the nodes include a receive center 104, two flow centers 106a, 106b, four retail stores 108a, 108b, 108c, 108d, and three customer residences 110a, 110b, 110c. In practice, the supply chain could include many more nodes in different proportions. In some embodiments, there are not separate receive centers and flow centers. Instead, there may be one type of warehouse or distribution center for holding inventory before distributing to stores and customers. Arrows in the diagram indicate movement of inventory. Inventory will typically flow downward through the supply chain, but in some instances inventory may move between flow centers 106 or between retail stores 108. In some embodiments, inventory may even move from a flow center 106 to a receive center 104 or from a retail store 108 to a flow center 106.

Vendors 102 produce/provide the items or products that will be sold by the retail entity. A purchase order is typically placed to request products from a vendor. In some instances, the vendor 102 will transport the ordered products to a receive center 104. In other instances, the retail entity arranges for the products to be picked up from the vendor 102 and transported to the receive center 104. Once at the receive center 104, the products are prepared for transportation to one or more flow centers. The products may arrive from the vendors in large groupings that need to be broken down into individual units for distribution to flow centers 106 and/or stores 108. Accordingly, once received into the supply chain of the enterprise, each individual unit can be tracked and shipped among the various nodes of the supply chain (receive centers 104, flow centers 106, and stores 108).

A variety of products are prepared for shipment to one or more flow centers 106. The flow centers 106 are typically positioned to enable quick shipment to one or more retail stores 108. Each flow center 106 may supply inventory to multiple retail stores 108. In some instances, more than one flow center 106 will send inventory to a retail store 108. For example, in FIG. 1, flow center 106a distributes inventory to stores 108a, 108b, and 108c. Flow center 106b distributes to stores 108b, 108c, and 108d. In some instances, to the extent products received at a flow center 106 are not already broken down into individual units, the products may be broken down into individual units in order to distribute individual items to stores 108, or optionally to fill online orders that will be delivered directly to customers from the flow center 106 or store 108. In the example of FIG. 1, products are shipped directly from flow center 106a to a customer 110a and from flow center 106b to customer 110c.

Once products arrive at the retail stores 108, they are either stored in a back room or displayed on shelves. This inventory is available for in-store purchases, pick-up orders, or local delivery. Depending on the location of a customer ordering products online, the shipments of products could come from one or more retail stores 108, or flow centers 106. For instance, customer 110b could receive shipments of products from either store 108b or store 108c, or both (in the instance of a multi-item purchase).

It is noted that, between receive centers 108, flow centers 106, and stores 108, there may be preexisting, predetermined delivery routes established. For example, there may be daily or weekly transit routes between a receive center and one or more flow centers. The receive center can provide to the flow centers the selection of individual items that are needed by stores 108 serviced by the one or more flow centers proximate to and/or servicing those stores. The flow centers can also have daily or other periodic transportation routes established to stores that are serviced, thereby ensuring prompt replenishment of items at stores in response to item sales.

In addition, the predetermined delivery routes can be used for various purposes. For example, in some situations, the predetermined delivery routes can be used to deliver products in various forms. As explained in further detail below, items distributed via the supply chain are tracked on an individual (per-item) basis; as such, items can be delivered to stores 108 in any convenient manner. In some example embodiments, items are tracked on an individual basis, but may be grouped at a flow center 106 to simplify restocking of the store 108, for example by placing together in a package a collection of individual items of different types but which may easily be stocked conveniently once those items arrive at a store 108. For example, goods that are located in a common department, row, or shelf of a store can be grouped and packed together at the flow center 106. Once those items reach the store 108, a restocking operation can restock each of the items in that shelf, row, or department easily. Still further, because items are packed and tracked on an individual basis at the flow center and sent to stores based, at least in part, on demand signals received from stores, the item collections are based on the number of items sold and therefore the restocking operation can provide a package of items that will fit on store shelves, rather than requiring additional backroom stocking and storage.

In the context of the present disclosure, a supply chain management system is provided that assists in coordination of product shipments among nodes of the supply chain, and uses inventory models to automatically rebalance inventory within the supply chain of the enterprise to ensure predicted and actual item demand from customers of the enterprise is fulfilled to a predetermined threshold success rate. The supply chain management system allows for balancing of items across the supply chain based on inventory and demand models, as well as real time demand signals, and performs automated generation of purchase and transfer orders throughout the supply chain based on such demand and lead time calculations between paints both within and external to the supply chain. Accordingly, as noted below, substantial advantages are realized using the methods and systems of the present disclosure.

It is in this general supply chain retail environment that the following systems and methods operate. While the methods and systems are described in a retail environment having brick-and-mortar stores as well as online sales, additional applications are possible. For example, the systems and methods could operate in a supply chain of warehouses that only distribute products to customers in fulfillment of online orders. In other embodiments, the systems and methods could operate for distribution channels that distribute supplies to multiple locations within a business rather than selling to individual customers. Regardless of the application, the systems and methods described herein are most beneficial when used to manage a supply chain for a plurality of nodes with the goal of increasing efficiency of inventory movement by responding to both proactive and reactive demand signals in real time.

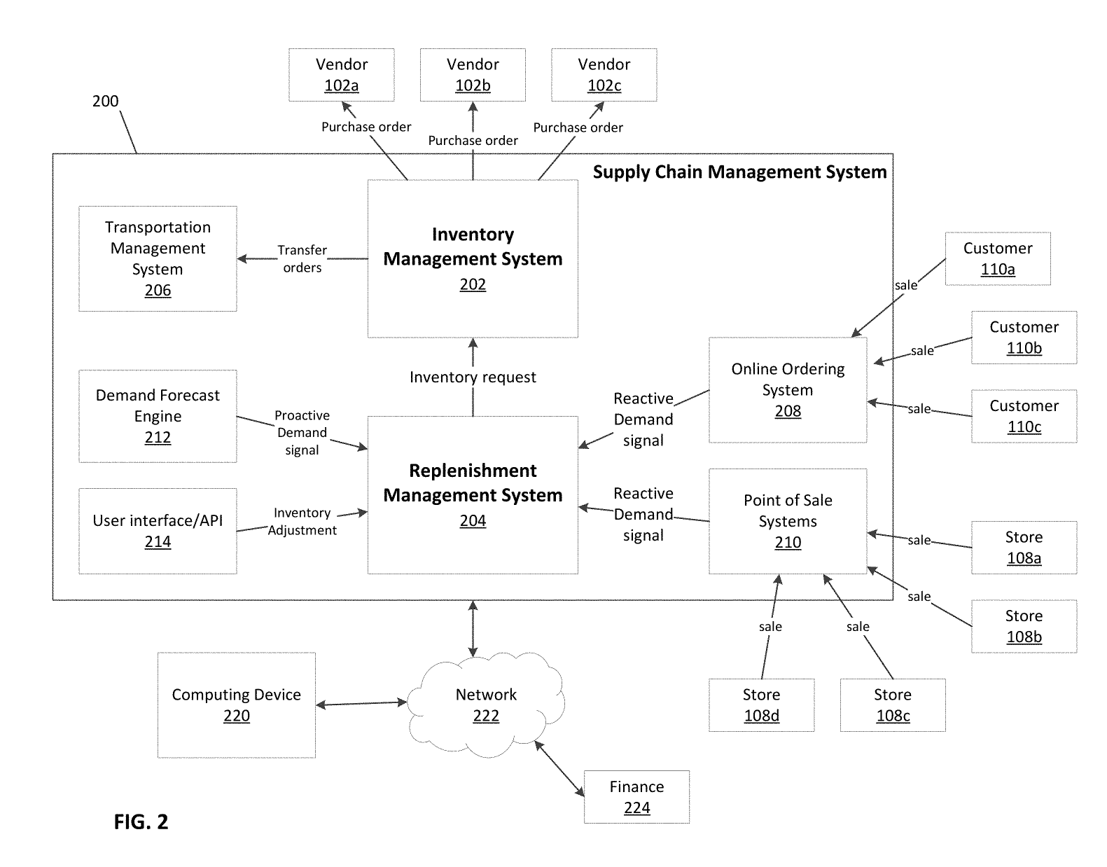

FIG. 2 illustrates a schematic diagram of an example system 200 for managing a supply chain. Components of the supply chain management system 200 include an inventory management system 202 and a replenishment management system 204. Together, the inventory management system 202 and replenishment management system 204 operate to monitor inventory levels across all nodes of a supply chain, determine if and when adjustments to inventory levels need to be made, and facilitate transport of inventory between nodes to respond to customer demand.

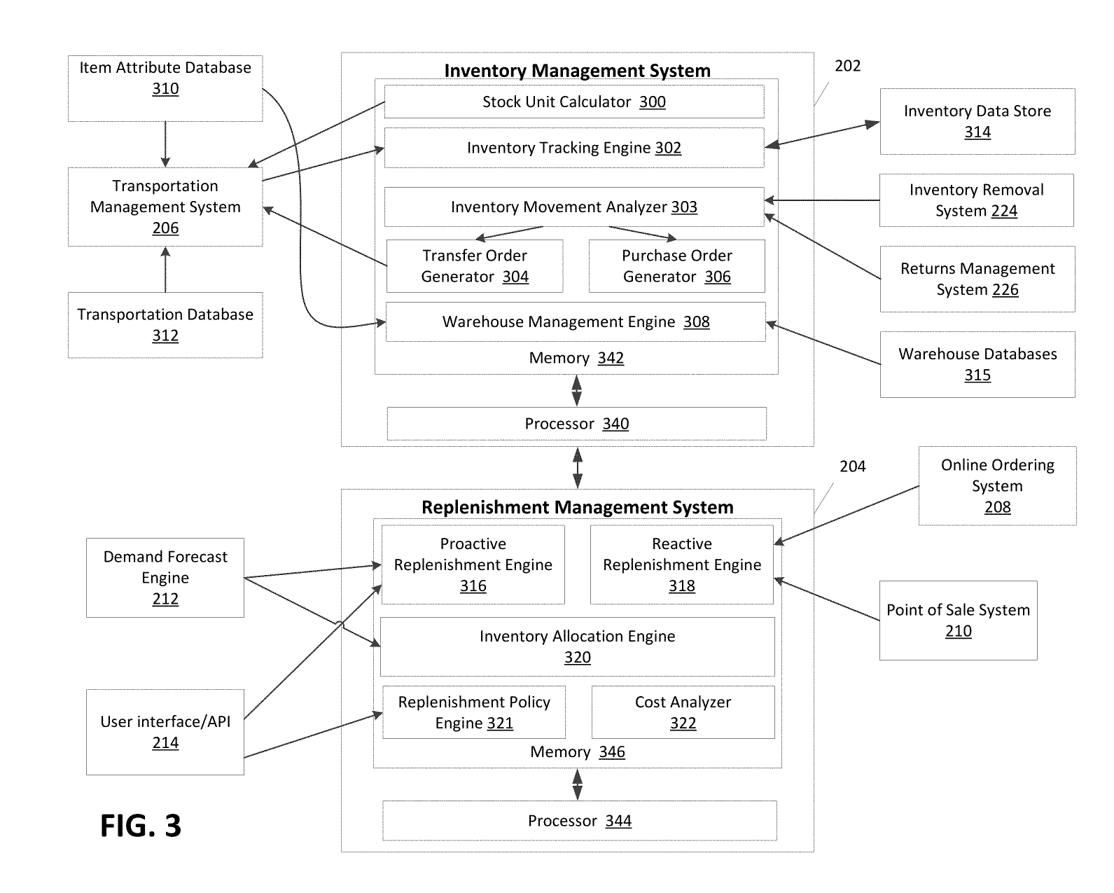

The inventory management system 202 receives inventory requests from the replenishment management system 204. In response to the inventory requests, the inventory management system 202 determines whether additional inventory is needed at one or more nodes within the supply chain to satisfy the request. Additional inventory may be transported to one node from another node if sufficient stock of the needed product(s) is available within the required timeframe within the supply chain. In such instances, transfer orders are issued to the transportation management system 206. If the inventory management system 202 determines that there is not sufficient stock of the requested products at another node or that transporting the products within the supply chain would be too costly or time consuming, additional stock is ordered from one or more vendors 102 through purchase orders issued from the inventory management system 202. The inventory management system 202 is further described with respect to FIG. 3.

In the embodiment shown, the replenishment management system 204 receives demand signals from one or more sources including an online ordering system 208, one or more point of sale systems 210, and a demand forecast engine 212. The demand signals can be proactive or reactive. Proactive demand signals are received from the demand forecast engine 212 and are generated by predicting expected customer demand for individual products on a day by day basis. Reactive demand signals are received from the point of sale system 210 (e.g., a point of sale network distributed across stores 108 within the enterprise) or through the online ordering system 208. The online ordering system 208 receives orders from customers 110 and coordinates fulfillment of those orders. The point of sale systems 210 record sales that are made at stores 108. The replenishment management system 204 also receives inventory adjustments from the user interface 214. Inventory adjustments are instructions received from a user to modify inventory levels at one or more locations or nodes within the supply chain. Inventory adjustments may be made for reasons other than expected or actual customer demand for particular items. The replenishment management system 204 is further described with respect to FIG. 3.

In some embodiments the supply chain management system 200 communicates with a computing device 220 through a network 222. The network 222 can be any of a variety of types of public or private communications networks, such as the Internet. The computing device 220 can be any network-connected device including desktop computers, laptop computers, tablet computing devices, smartphones, and other devices capable of connecting to the Internet through wireless or wired connections. In some instances, the supply chain management system 200 also communicates with a finance system 224 through the network 222.

FIG. 3 shows a detailed schematic of example embodiments of the inventory management system 202 and replenishment management system 204. In the example shown, the inventory management system 202 includes a stock unit calculator 300, an inventory tracking engine 302, inventory movement analyzer 303, a transfer order generator 304, a purchase order generator 306, and a warehouse management engine 308.

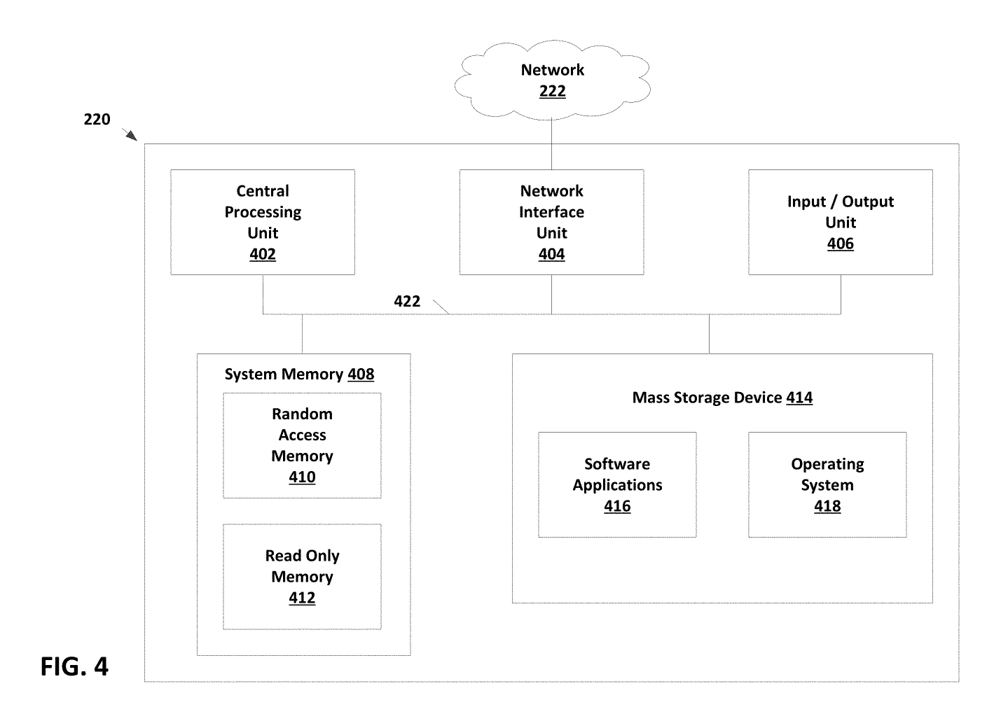

The inventory management system 202 is implemented on one or more computing systems within an enterprise network. Accordingly, the inventory management system 202 includes a processor 340 and memory 342 operatively connected to the processor, and storing operating instructions that implement the operative components (300-308, above) of the system 202. An example computing system or systems with which system 202 can be implemented is illustrated below in connection with FIG. 4.

In example embodiments, the stock unit calculator 300 operates to determine the appropriate unit of measure in which each product should be transported and stored. In response to real-time events, inventory must be moved from place to place. By determining the amount of inventory that needs to be distributed, the proper unit of measure can be determined. In some cases, a node will need large batches of a particular item due to high demand. In such cases, full pallets could be transported. In other cases, a node may only need one or two of an item at a time. In those instances, the proper unit of measure is the individual units. The stock unit calculator 300 communicates with the inventory allocation engine 320 to determine storage requirements based on future demand forecasts for each product.

The stock unit calculator 300 will leverage predicted inventory movement to determine the appropriate unit of measure for storage and movement. The unit of measure determines items and quantities that should be stored in pallets, cartons, or broken down into eaches (individual units). Additionally, the stock unit calculator 300 determines when it is advantageous to round the unit of measure up to the next largest denomination. For example, pallets of bottled water arrive at a receive center. High volume stores will sell through 1-2 pallets while low volume stores will sell through 5-6 eaches between deliveries. Based on the probability of future demand, the stock unit calculator 300 determines how many pallets should be broken down into cases or eaches for storage in the receive center and/or transport. This enables faster loading of trucks for delivery to flow centers and stores so that the products do not have to be broken down into smaller units further down the supply chain.

The inventory tracking engine 302 operates to monitor inventory levels at each warehouse and store in the supply chain. The inventory tracking engine 302 also receives inputs from the transportation management system 206 regarding the movement of inventory between nodes. Inventory coming into the supply chain from vendors or returns is recorded by the inventory tracking engine 302 as well as inventory leaving the supply chain to satisfy sales or inventory removal. Updates to inventory records are saved in an inventory data store 314. The inventory tracking engine 302 serves as a single source of information for that status of every aspect of inventory within a supply chain for a retail enterprise. In some embodiments, the inventory tracking engine 302 can be implemented as disclosed in copending U.S. Provisional patent application Ser. No. ______, entitled “Method and System for Tracking Inventory”, the disclosure of which is hereby incorporated by reference in its entirety.

The inventory movement analyzer 303 receives status updates from the inventory tracking engine 302 and analyzes the changing inventory levels at each node within the supply chain to determine if any inventory movements are needed. The inventory movement analyzer 303 receives inventory requests from the replenishment management system 204, the inventory removal system 224, and the returns management system 226. Based on these inventory requests, the inventory movement analyzer 303 determines whether the inventory levels are at their preferred levels. The preferred levels are determined on a per-item basis for each day. The inventory goals could change from day to day for each item and node location. The inventory movement analyzer 303 evaluates the current inventory levels at each node and compares them to that day's goal and the following day's goal to determine if inventory movements need to be changed to redistribute inventory.

The inventory movement analyzer 303 determines how items should be moved between nodes of the supply chain, based on the inventory goals. If inventory is available within the supply chain to satisfy an inventory request and the costs are not too high to move the inventory, the inventory movement analyzer 303 will send a signal to the transfer order generator 304. If the inventory movement analyzer 303 determines that there is insufficient supply of an item within the supply chain to satisfy an inventory request or that the cost of moving items outweighs the cost of ordering new stock, the inventory movement analyzer 303 sends a signal to the purchase order generator 306.

The inventory removal system 224 and returns management system 226 provide inputs to the inventory movement analyzer 303 to request the movement of inventory within the supply chain. The inventory removal system 224 is responsible for removing items from the supply chain. In some instances, the items will be automatically removed after a period of time, for example, after a predetermined shelf life for perishable produce and other fresh grocery items. In other instances, the items are removed after the inventory removal system 224 receives a notification to remove one or more items from the supply chain. For example, one or more seasonal items may be removed at the conclusion of a particular shopping season. In another example, as discussed below, the items could be removed following a return if the items are no longer in condition for re-sale to another customer. Items may need to move to different nodes in order to be properly removed from the supply chain.

The returns management system 226 operates to determine how to redistribute items that have been returned by customers following a purchase. In some instances, the returned item or items are transferred to other nodes or remain where they were received from the customer. Those items are then made available for re-sale to another customer. In other instances, the returned item or items are not eligible for re-sale and are marked for removal from the supply chain by the inventory removal system 224.

The transfer order generator 304 communicates with the transportation management system 206 to transfer stock of products from one node to another. Transfer orders are generated when the inventory management system 202 has received an inventory request and the inventory movement analyzer 303 has determined that the additional inventory can be moved from another node. In some embodiments, the transfer order generator 304 can be implemented as disclosed in copending U.S. Provisional patent application Ser. No. ______, entitled “Method and System for Transfer Order Management”, the disclosure of which is hereby incorporated by reference in its entirety.

The purchase order generator 306 sends orders to vendors for additional stock of products. Purchase orders are generated when the inventory management system 202 has received an inventory request and the inventory movement analyzer 303 in conjunction with the cost analyzer 322 has determined that it would be more cost and/or time efficient to get the additional inventory from a vendor than from another node. Purchase orders are communicated to the transportation management system 206 in order for transportation of the products from the vendor to a receive center to be arranged.

The warehouse management engine 308 manages all events that occur at a warehouse or distribution center in the process of moving inventory through the supply chain. The functions of the warehouse management engine 308 differ for each node depending on that node's role. Warehouse operations are different between receive centers, flow centers, and storage in retail stores. The warehouse management system 308 relies on information supplied by the item attribute database 310 and warehouse databases 315.

Inbound processing typically occurs at receive centers and flow centers as items are shipped in from vendors or are transferred from other nodes within the supply chain. The inbound process handles inventory that is to be put into storage at a distribution center or warehouse. The purpose of the inbound functions of the warehouse management engine 308 are to quickly get items into the warehouse, confirm quality of goods and all associated data, prepare goods if needed for downstream movement and proper unit of measure, direct items to the correct storage area, and accurately put into a location that maximizes cube utilization. Once these functions are completed, inventory is reported to the inventory data store 314 for recordation as available stock.

For vendor loads, purchase order specific instructions are delivered from the inventory management system 202 that dictate the unit of measure it should be stored in as well as indicates if freight is crossdock and should be moved through the facility to be received and prepped at another node. Non-crossdock vendor freight is unloaded and sorted for receiving based on the physical size, storage unit of measure, and preparation requirements of the goods. This information is accessed from the item attribute database 310. Throughout these processes, the warehouse management engine 308 and transportation management system 206 is providing real-time updates to the inventory tracking engine 302 which records the updates in the inventory data store 314. The inventory data store 314 serves as the single source of truth for inventory ownership supplying all other aspects of the supply chain management system 200.

For transfer loads, the receive process is not necessary as all of the prep and appropriate building of put away vessels has been done by the supplying node. Therefore, the process is much simpler and faster as vessels are pulled directly from the inbound trailer, checked in to take financial and unit ownership, and then taken directly to the appropriate warehouse location or automation structure to be put away/inducted. During this process the warehouse management engine 308 directs the items to correct warehouse locations and provides updates to the inventory tracking engine 302.

In the put away process, the role of the warehouse management engine 308 is one of accuracy and tracking rather than direction. Put away from either transfer or vendor loads looks the same, only differentiated by unit of measure and size (each, case, pallet, S/M/L/XL). Inventory can therefore be accurately located in the correct unit of measure, prepared for future movement, and be available for the online ordering system 208 to allocate against.

The outbound functions of the warehouse management engine 308 are more complex based on the need for optimization to occur. Tight control and coordination of operational activities are necessary to meet ease of customer handling requirements without massive buffers or long cycle times. The outbound cycle begins by receiving movement instructions the inventory movement analyzer 303. These can be either replenishment, proactive transfers, or reactive transfers but all types include the item, quantity, unit of measure specification, destination, any customer requirements (i.e., gift wrapped), and need by time information. The warehouse management engine 308 receives these instructions throughout the day as sales and guest orders occur.

Due to the complexity of merging both stores replenishment and direct to guest operations, sequencing requirements for store ease of handling, the need to balance throughput across the operation, and tight cycle time requirements the warehouse management engine 308 employs sophisticated “sort” logic. This logic dynamically assesses orders in the pool and the operational constraints of all outbound functions in the facility. Based on this, it groups work and drops it to the floor to begin the pick process based on an optimized understanding of how that work will move through sortation, packing, and shipping functions to ultimately generate a completed easy to handle vessel that can be loaded onto a trailer without the need for massive buffers or overbuilt throughput.

For goods that require sortation after the picking operation but prior to the packing operation, the warehouse management engine 308 communicates with the sorter controls alerting it to the necessary destination within the facility of any inducted freight. The sorter then executes these physical movements and goods arrive at the correct packing station, at the right time, to be merged with other goods during packing to complete a store or guest order.

In the packing operation, the warehouse management engine 308 operates in conjunction with the transportation management system 202 to optimize use of space in trailers and other transportation equipment. Vessel sizes are selected that ensure product protection while minimizing cube loss (internal and external). Completed pack vessels are directed to the appropriate ship sequencing area of the warehouse where the final step of sequencing occurs to complete the ease of handling requirement. Once groupings are completed at the physical vessel level, the transportation management system 202 directs the loading of vessels onto the trailer in the appropriate order for later unloading.

The transportation management system 206 receives instructions from the inventory management system 202 to transport inventory between nodes of the supply chain. This includes shipping stock from vendors to warehouses to stores and then to customers. The transportation management system 206 receives transfer orders and purchase orders from the inventory management system 202 and arranges for the transportation of the requested products. As mentioned above, the transportation management system 206 operates in conjunction with the warehouse management engine 308 to coordinate packing and unpacking of trailers at warehouse locations.

The transportation management system 206 determines the best way to move items from place to place within given time periods in the most cost effective way. The system balances speed, service, and cost levels to drive optimal outcomes for inventory movement. The transportation management system 206 ensures that shipments of inventory arrive by critical “need-by” times dictated by the level of service associated with a customer order.

The transportation management system 206 accesses information about the items to be shipped from the item attribute database 310. Item attributes include information about whether particular items need to be temperature controlled (e.g. freezer), whether the items contain hazardous materials and require special handling, whether the items are flammable, the items' dimensions and weights, whether the items are bulky, etc.

The stock unit calculator 300 provides information regarding the number of individual units per pallet or other unit of measure of multiple items is included. Some items are stored individually while others are typically stored and shipped in multiples. For example, small items like towels might be packaged into boxes of 12 and those boxes are then packaged into pallets of 8 boxes. Such a calculator can be used to determine conversions between units ordered or received as reflected on a purchase order and eaches generated therefrom for subsequent shipment.

The transportation management system 206 accesses information in the transportation database 312 to select proper transportation equipment for conveying the required items to their destination. Transportation equipment is selected based on the attributes of the items as well as cost, availability, etc. The system schedules deliveries of shipments and executes delivery services tailed to each node and recipient. To schedule the transportation of inventory, the system selects a carrier service based on the expected transit times and transit expenses. The system also optimizes routing to consolidate trips and create multi-stop opportunities to increase efficiency.

The transportation management system 206 handles arrangements for obtaining items from vendors and ensuring that the items arrive at the appropriate warehouses within an appropriate timeframe while minimizing costs. The transportation management system 206 sends purchase orders to vendors and schedules pick-up times for receiving the ordered items. A pick-up window or time is determined based on the need-by-time and anticipated transit times, as well as the vendor hours and ship point constraints.

The transportation management system 206 also determines which types of transportation equipment are needed to transport the ordered items from the vendor to the warehouse. For example, the equipment may need to handle hazardous items or temperature sensitive items. Also, the equipment must be sized appropriately to handle the number of items that are being received by the vendor. In some instances, the equipment may be scheduled for more than one pick-up, so the equipment must be compatible with all of the items that it is scheduled to pick up. The system will determine which warehouse the vendor items are to be delivered in ordered to position the items for more efficient distribution to other warehouses and retail stores.

An item attribute database 310 stores information about attributes of the items or products that are being shipped and sold within the supply chain. Attributes of the products include weight, volume, units, and whether particular handling is required. Special handling may be required for items that require refrigeration, items that are flammable, or other hazardous materials in items. The transportation management system 206 relies on information in the item attribute database 310 to select equipment for transporting items as well as managing storage of the items in warehouses.

A transportation database 312 stores information about transportation equipment, transit times, delivery schedules, personnel, and outside contractors. The transportation equipment includes trucks, trailers, and other delivery equipment. Transit times are calculated for regular shipments as well as “milk runs” or extra rush deliveries as well as transit times that are required if using outside contractors. Delivery schedules include regular deliveries within the supply chain, vendor availability windows, and warehouse operating hours. Personnel information includes data for available personnel to staff the transportation equipment, cost of using internal personnel, and cost of hiring outside contractors.

The inventory data store 314 houses information about current inventory levels at all of the nodes within the supply chain. Inventory levels are recorded for each item or product. The inventory data store 314 is continually updated by the inventory tracking engine 302 and provides a real-time view of the status of inventory levels across all nodes within the supply chain.

Warehouse databases 315 store information about warehouses (distribution centers) within the supply chain. The information includes data about available storage space, availability of specialized storage space (e.g. refrigerator or freezer space), and whether certain areas within the warehouse are reserved for particular items or purposes. The inventory management system 202 utilizes the warehouse databases 315 to determine loading orders of products in trailers and communicates that information to the transportation management system 206. The warehouse databases 315 are also used in conjunction with the stock unit calculator 300 to determine proper units of measure for storing products in distribution centers.

In the embodiment shown, the replenishment management system 204 includes a proactive inventory replenishment engine 316, a reactive inventory replenishment engine 318, an inventory allocation engine 320, a replenishment policy engine 321, and a cost analyzer 322. The replenishment management system 204 also includes a processor 344 operatively connected to a memory 346. The replenishment management system 204 receives demand signals from the demand forecast engine 212, the point of sale system 210, and the online ordering system 208. The replenishment management system 204 receives further instructions from the user interface 214.

The proactive replenishment engine 316 receives proactive demand signals from the demand forecast engine 212 and user interface 214. These demand signals come in the form of a forecasted demand probability distribution that is determined for each item, at each location, for a given timeframe. Demand probability distributions are further described below. The demand probability distributions are utilized by the inventory allocation engine 320 to determine the optimized inventory positions of each item in the supply chain. The proactive replenishment engine 316 operates to ensure that inventory is replenished to keep up with anticipated demand.

A proactive transfer moves goods within the supply chain in advance of demand so that the proper amount of safety stock exists at each location. Stock is preferably moved along existing travel routes between nodes of the supply chain. This provides efficiency as well as tremendous flexibility to rebalance inventory throughout the network; eliminating out of stocks while lowering overall inventory levels.

The reactive replenishment engine 318 receives reactive demand signals from the point of sale system 210 and the online ordering system 208. Reactive replenishment ensures that stock levels remain at the preferred levels to meet customer availability goals.

A reactive transfer or shipping injection occurs as response to a reactive demand signal from a customer order made online or a purchase made in-store. For a reactive transfer, the reactive replenishment engine 318 sends a request to the inventory management system 202, but the full order cannot be completed at a single node. Therefore, portions of the order move through the network to land at a final processing node (normally the store) for combination and final order completion. This can happen through multiple echelons of the supply chain and the difference in lead time between a reactive transfer coming from receive center through flow center to store (2+ days) or from flow center to store (1+ day) is messaged to the online customer through the “promise” or guaranteed delivery date. Once all portions of an order have arrived at the final processing node via reactive transfer and the order can be completed, it is combined, processed, and sent out for delivery.

Shipping injection refers to a guest order that is fully complete and ready for guest delivery. The process is very similar to that of a reactive transfer but rather than doing final order combination from parts at the store, the order is combined, processed, and completed further upstream and sent downstream in its completed state ready for injection without additional store processing prior to being sent from the store for local injection.

Specific sequencing of reactive transfer orders within the supply chain are optimized to maximize opportunities to arrive at outbound trailers and processing windows within the operation. For example, reactive transfers can bypass put away and storage without compromising the ability to sequence store freight by being loaded directly into a vessel that is kept open throughout the load. This reactive vessel is loaded just prior to trailer close ensuring that every possible minute is available for reactive transfers to make the trailer cut. This strategy allows reactive transfers to represent a “magic bullet” through the supply chain consistently being the last orders on outbound shipments and the first orders off of inbound shipments.

The inventory allocation engine 320 operates to determine optimized inventory positions by item, location, and timeframe for each node within the supply chain. The inventory allocation engine 320 relies on demand probability distributions from the demand forecast engine 212 to inform decision-making about the position of inventory within the supply chain. The inventory allocation engine 320 also modifies the optimized inventory positions based on accessing policies from the replenishment policy engine 321.

The forecasted demand probability distribution must be determined for each item, at each location, for a given timeframe. This demand probability distribution may change based on time of year due to promotions, holidays, etc. The cost of holding inventory at each location for each item at different times of year must be determined. The inventory allocation engine 320 operates in conjunction with the cost analyzer 322 to compare various costs. This informs the decision of whether to hold inventory upstream in a flow center or receive center rather than keeping additional stock at the store.

The availability goal for each item at each location for different time periods must also be determined. This applies to both online and in-store purchase. The availability goal determines how much stock is needed to meet an expected demand from customers. The current inventory levels must be determined for each node and the amount of time it will take to transport inventory between nodes must be determined. The cost of moving inventory must also be determined. Additional constraints include the amount of available storage at each node, the availability of transportation, the times of day that inventory can be delivered, minimum order sizes, order frequency cycle restrictions, vendor restrictions, etc.

The objective of the inventory allocation engine 320 is to work with the proactive replenishment engine 316 to position inventory for future sales demand and rebalance safety stock in flow centers and receive centers. Safety stock is extra inventory maintained to mitigate risk of stockouts (shortfalls in available inventory). The inventory allocation engine 320 will provide future need-by date and times for optimized replenishment thresholds by item and location in stores and safety stock levels in flow centers and receive centers to reflect the policies provided by the replenishment policy engine 321. In conjunction with the replenishment policy engine 321, the inventory allocation engine determines 1) initial inventory positioning for new items 2) changes in positioning to support upcoming sales events/promotions or 3) inventory movements required to rebalance safety stock across the network. Proactive transfers move inventory from receive center to receive center, receive center to flow center, flow center to flow center and flow center to store.

The inventory allocation engine 320 operates to determine optimized inventory positions, in the appropriate unit of measure, at all nodes of the supply chain. The inventory allocation engine 320 utilizes proactive demand signals received from the demand forecast engine 212 to calculate the optimized inventory positions for a plurality of products. The inventory allocation engine 320 also ensures that the optimized inventory positions comply with the replenishment policies received from the replenishment policy engine 321. The optimized inventory positions determine how much inventory should be carried at any period of an item's lifecycle (i.e. push, pull, etc.), where the inventory should be and when it is needed (current or future). The optimized inventory positions are communicated to the inventory management system 202, which determines if any inventory needs to be moved or ordered to satisfy the optimized inventory positions at any given time.

The first problem of determining the optimized inventory positions will be solved by leveraging and expanding upon an optimal inventory policy approach for multi echelon supply chains developed by Clark-Scarf. Clark-Scarf's approach will do joint optimization across all nodes considering inputs such as forecasted probability of demand, availability goals and trade off costs (cost to hold, cost to move, etc.) for each node to support availability for a customer. The forecasted probability of demand is determined for each item at each location for a given timeframe by the demand forecast engine 212. This determines the probability of selling or fulfilling a particular quantity of an item, at each location, each day of the week, and whether that materially changes based on the time of year. The forecasted probability of demand also accounts for upcoming known promotions as well as historical lost sales due to stock-outs.

The inventory allocation engine 320 works by balancing the desired product availability (store and online) with the cost of holding inventory in a node to support it and results in a portion of the required inventory being held upstream instead of exclusively at a store. The product availability goal is determined by the overall retail enterprise and is the amount of availability for each item at each location at different time periods that is set for both online and in-store customers. For example, pumpkin pie filling may have a higher availability goal at Thanksgiving than other times of year. Availability goals can be adjusted to reflect the importance of the product to the customers at that time of year. Availability goals may be adjusted through the user interface 214, which communicates with the replenishment policy engine 321.

The replenishment policy engine 321 receives inputs from the user interface 214 to modify the optimized inventory positions and replenishment procedures. The replenishment procedures and optimized inventory positions may be modified for particular promotional events, in advance of seasonal changes in demand, or other inputs from a user. The replenishment policy engine 321 keeps track of inputs from the user interface 214 and mediates time-based changes in replenishment procedures and optimized inventory positions. For instance, the replenishment policy engine 321 could change the replenishment schedule from once daily to twice daily based on inputs at the user interface 214. In other instances, the replenishment policy engine 321 could change the replenishment schedule from a per-item basis to replenishing only when at least two units of a particular item need to be moved.

How much inventory can be held upstream is governed by the transit lead times between echelons and mathematically balancing guest availability with inventory holding costs in each node. The cost analyzer 322 performs this balancing function. The cost analyzer 322 accesses information regarding each location's cost of holding particular items at different times of the year from warehouse databases 312. This information is used to calculate whether and when it is more advantageous to hold inventory upstream in a flow center or receive center instead of sending additional quantities of a particular item to a store.

Factors considered for this calculation include interest on inventory, storage and maintenance costs, real estate space, etc. Transit lead times for each movement between nodes are calculated by the transportation management system 206 and stored in a transportation database 312 which is accessible by the replenishment management system 204. The cost of moving inventory between nodes may change at different times of year based on volume density. The transportation management system 206 also determines trailer availability for transporting inventory, delivery day/time restrictions, and other factors relating to transportation of products between vendors and nodes within the supply chain.

When the inventory allocation engine 320 considers multiple stores 108 serviced by a flow center and multiple flow centers 106 serviced by a receive center 104, it can begin to realize the additional advantage of risk pooling —which suggests that demand variability is reduced when demand is aggregated across locations (it becomes more likely that higher than expected demand from one location/customer will be offset by lower demand from another). This reduction in variability allows a further decrease in safety stock and average inventory in total. This design enables the system to account for demand uncertainty (sales higher/lower than expected) and forecast error while still maintaining availability. The highest degree of uncertainty will be experienced at the store level with progressively less uncertainty further up the supply chain at the flow center and receive center levels. Leveraging this logic along with the ability to quickly redeploy inventory and ship in eaches, will allow the overall retail enterprise to carry significantly less safety stock.

The cost analyzer 322 is also integrated into other decisions and movements within the supply chain. There is often a tradeoff between competing replenishment, proactive transfer and fulfillment needs when it comes to fulfilling orders from both online and in-store purchases. The reactive replenishment engine 318 will assign various types of orders to the best node available while minimizing both the direct supply chain costs and opportunity costs associated with any required tradeoffs. The inventory management system 202 takes into account both online and in-store purchases and orders when considering where to take inventory from. The cost analyzer 322 weighs the options for transfers versus purchase orders as well as determining which nodes transfers should come from.

To help determine the best use of inventory, the cost analyzer 322 will calculate the total cost for each option. The total cost will be the sum of the direct cost (fulfillment and transportation costs) and the opportunity cost. The opportunity cost will reflect the potential return on inventory for an alternative use of the inventory (e.g. if the reactive replenishment engine 318 uses inventory to fulfill an online order, the inventory will not be used to meet a replenishment need—the calculation will quantify the impact of not replenishing). The calculation will be designed to achieve the following priorities: 1) meet promise for a guest order; 2) lower the risk of a lost sale or being out of stock in a store; and 3) minimize the direct and opportunity costs associated with a unit of inventory. The cost analyzer 322 will recommend vendor purchases over rebalancing moves when transportation costs are excessive.

The online ordering system 208 receives orders from customers made online. The online ordering system 208 processes the orders and submits them to the replenishment management system 204 for processing. The transportation management system 206 and inventory management system 202 operate together to fill the order and deliver the ordered products to the customer in the need-by time.

The online ordering system 208 operates in conjunction with the reactive replenishment engine 318 to determine which items are available within the inventory and the timeline in which the customer can receive the item either in-store or by home delivery. The inventory will be segmented based on when the items can be delivered to the customers. The online ordering system 208 interfaces with the inventory tracking engine 302 to determine the current location of items and calculate how long it will take for an item to reach a customer. These calculated times are used to provide delivery windows for a customer ordering an item.

The inventory management system 202 calculates windows of time that are within specific hours of a day to inform customers when the items they ordered will be available for pick-up at a store. Similar windows can be calculated for delivery. In some cases, the pick-up or delivery times can be within one day (24 hours) or less. In some instances the systems will calculate different shipping prices depending on when the customer would like to pick up or receive delivery of an item. In such instances, the shipping fees may increase the faster the customer receives the item. This will generally reflect the reality that expedited shipping methods will need to be utilized.

To be able to determine which inventory is available for order and when it will be available, the following inputs are required. First, the inventory that is able to be committed by node, service offering, and time available must be determined. Then the capabilities for the market where the order was placed must be determined. The system determines the available service offerings, inventory rules/limitations, and available delivery zip codes for the given market. Then the pickup or delivery time windows are determined. The store pickup and drive up delivery capacity is determined by the hour. The same day carrier delivery capacity is determined by the hour. Finally, the operations capabilities relevant to the customer location are determined. The inputs to determine here include: eligible locations, capabilities, and cutoff times; carrier pickup times; processing and transit times; and transportation calendars.

The online ordering system 208 will then be able to provide guaranteed arrival times to customers placing orders online. Different arrival times will be calculated for the customer's address or chosen pick-up store based on the items selected and service selected (pick-up, same-day delivery, etc). Urgency messaging can be provided to the customer at the time of check-out. Such messages may read “order by 9 PM today and receive item by 6 PM tomorrow” or “order within 45 minutes and item will be ready for pickup within 2 hours.” Upon placing the order, the system can generate a message to the customer to provide a guaranteed window of time in which the item will be available for pickup or delivery. For example, the window of time may be 24 hours, 12 hours, 6 hours, 4 hours, or 2 hours.

The inventory management system 202 is able to differentiate service offerings based on customer delivery address or selected store. Depending on the geographical area, the system can determine which and how many of each item can be committed to deliver to that customer and in which time frame.

The objective of the online order allocation logic is to assign an order consistent with the inventory placement and positioning strategy. The online ordering system 208 will assign orders to the node which is closest to the customer, meets the promised delivery date, and has the ability to consolidate the order. The system will support broader objectives to increase speed of delivery to guests while minimizing costs as much as possible by reducing splits and fulfilling via local injection as much as possible.

There will be instances in which a replenishment order, proactive transfer order, reactive transfer order or online order will compete for a unit of inventory in any flow center or receive center. In these situations where there is more demand for the units than forecasted, the reactive replenishment engine 318 will be required to tradeoff between replenishment, proactive transfer and fulfillment needs to determine which order to assign the units. Additionally, there may be situations where the replenishment management system 204 issues a vendor purchase request because it is less expensive than the transportation costs required to rebalance inventory.

A point of sale system 210 sends reactive demand signals to the reactive replenishment engine 318. In the embodiment illustrated in FIG. 3, there is only one point of sale system 210. In other embodiments, there may be multiple point of sale systems or no point of sale systems. The point of sale system 210 records sales made in retail stores and reports those sales to the reactive replenishment engine 318. The reactive replenishment engine 318 then determines if inventory levels need to be replenished at one or more nodes of the supply chain in order to achieve the optimized inventory positions for the following day.

Referring now to FIG. 4, an example block diagram of a computing system 220 is shown that is useable to implement aspects of the supply chain management system 200 of FIG. 2. In the embodiment shown, the computing system 220 includes at least one central processing unit (“CPU”) 402, a system memory 408, and a system bus 422 that couples the system memory 408 to the CPU 402. The system memory 408 includes a random access memory (“RAM”) 410 and a read-only memory (“ROM”) 412. A basic input/output system that contains the basic routines that help to transfer information between elements within the computing system 220, such as during startup, is stored in the ROM 24412. The computing system 20420 further includes a mass storage device 414. The mass storage device 414 is able to store software instructions and data.

The mass storage device 414 is connected to the CPU 402 through a mass storage controller (not shown) connected to the system bus 422. The mass storage device 414 and its associated computer-readable storage media provide non-volatile, non-transitory data storage for the computing system 400. Although the description of computer-readable storage media contained herein refers to a mass storage device, such as a hard disk or solid state disk, it should be appreciated by those skilled in the art that computer-readable data storage media can include any available tangible, physical device or article of manufacture from which the CPU 402 can read data and/or instructions. In certain embodiments, the computer-readable storage media comprises entirely non-transitory media.

Computer-readable storage media include volatile and non-volatile, removable and non-removable media implemented in any method or technology for storage of information such as computer-readable software instructions, data structures, program modules or other data. Example types of computer-readable data storage media include, but are not limited to, RAM, ROM, EPROM, EEPROM, flash memory or other solid state memory technology, CD-ROMs, digital versatile discs (“DVDs”), other optical storage media, magnetic cassettes, magnetic tape, magnetic disk storage or other magnetic storage devices, or any other medium which can be used to store the desired information and which can be accessed by the computing system 220.

According to various embodiments of the invention, the computing system 220 may operate in a networked environment using logical connections to remote network devices through a network 222, such as a wireless network, the Internet, or another type of network. The computing system 220 may connect to the network 222 through a network interface unit 404 connected to the system bus 422. It should be appreciated that the network interface unit 404 may also be utilized to connect to other types of networks and remote computing systems. The computing system 220 also includes an input/output controller 406 for receiving and processing input from a number of other devices, including a touch user interface display screen, or another type of input device. Similarly, the input/output controller 406 may provide output to a touch user interface display screen or other type of output device.

As mentioned briefly above, the mass storage device 414 and the RAM 410 of the computing system 220 can store software instructions and data. The software instructions include an operating system 418 suitable for controlling the operation of the computing system 220. The mass storage device 414 and/or the RAM 410 also store software instructions, that when executed by the CPU 402, cause the computing system 220 to provide the functionality discussed in this document. For example, the mass storage device 414 and/or the RAM 410 can store software instructions that, when executed by the CPU 402, cause the computing system 220 to receive and analyze inventory and demand data.

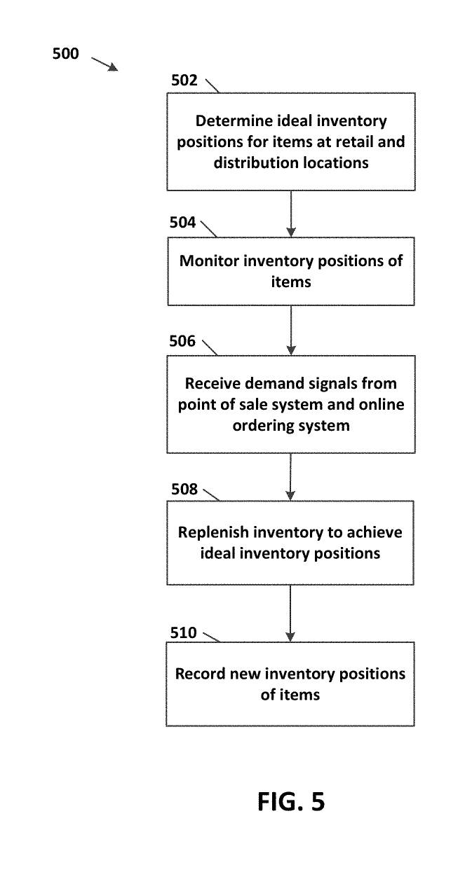

FIG. 5 displays a flow diagram of a method 500 of managing inventory replenishment within a retail supply chain. The supply chain includes a plurality of retail locations and a plurality of distribution locations. The supply chain may be structured like the example supply chain depicted in FIG. 1. In some embodiments, the method 500 is performed by a supply chain management system such as the system 200 of FIG. 2.

At operation 502, the optimized inventory positions for each of a plurality of items at each of the plurality of retail locations and distribution locations are determined. Optimized inventory positions are determined by the inventory allocation engine 320 of FIG. 3. As described above, the optimized inventory positions dictate the number of units of each item that are to be held at each node within the supply chain for a given timeframe. Inventory is held at these positions in order to quickly replenish stock in response to expected customer demand from stores and online sales.

Once optimized inventory positions are established, the inventory management system 202 will use the current inventory levels (monitored by the Inventory Tracking Engine 302) and calculated future optimized inventory positions (including the time they are needed in the receiving destination) to pre-position inventory for upcoming events (promotions, sales plans, new item sets, etc.) or other expected changes in sales patterns.

At operation 504, the inventory positions of the plurality of items at each of the retail locations and distribution locations are monitored. In some embodiments, the inventory positions are monitored by the inventory tracking engine 302. The inventory tracking engine 302 receives updates on inventory positions from the transportation management system 206 and the warehouse management engine 308 as items flows through the supply chain. Changes are recorded in the inventory data store 314.

At operation 506, demand signals are received from a point of sale system 210 in communication with the plurality of retail locations and an online ordering system 208. The demand signals are reactive demand signals that are received by the reactive replenishment engine 318 whenever sales are made.

In response to the demand signals, the inventory is replenished to achieve optimized inventory positions at operation 508. The reactive replenishment engine 318 communicates with the inventory management system 202 to direct movement of inventory to retail stores and distribution centers that require replenishment to achieve the optimized inventory positions that were determined by the inventory allocation engine 320 at operation 502. In some instances, reactive demand signals prompt movement of items to customers and in other instances the system replenishes stock of items in stores.

At operation 510, the new inventory positions of each item in each location are recorded in an inventory data store. The inventory tracking engine 302 receives notifications of the new locations of items within the supply chain and communicates that information to the inventory data store 314.

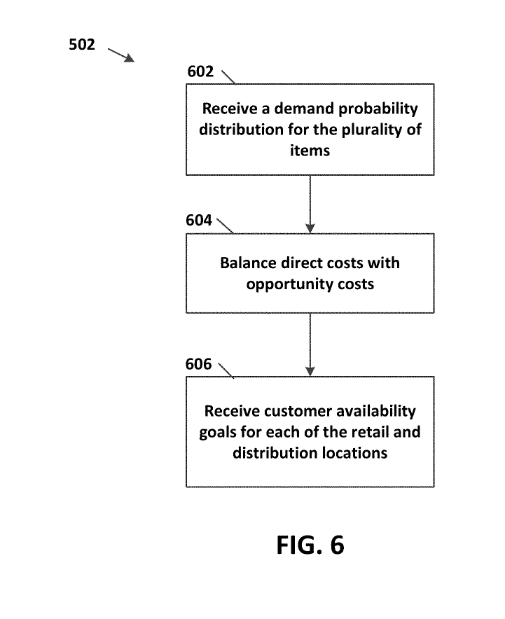

FIG. 6 illustrates an example method 502 of determining optimized inventory positions for items within a supply chain. One or more of the steps of this method may be optional in some embodiments. The method may be performed by the inventory allocation engine 320 of FIG. 3.

At operation 602, a demand probability distribution is received for the plurality of items at each of a plurality of retail locations and distribution locations. In some embodiments, the demand probability distribution is received from a demand forecast engine 212.

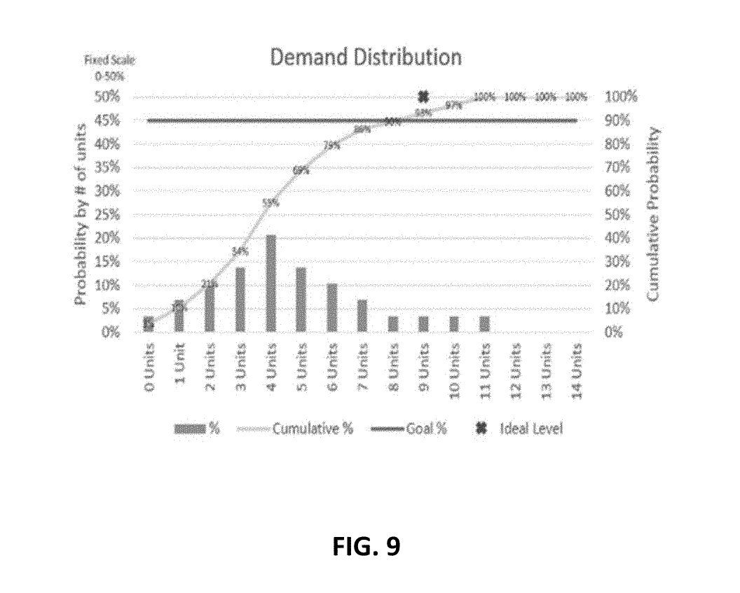

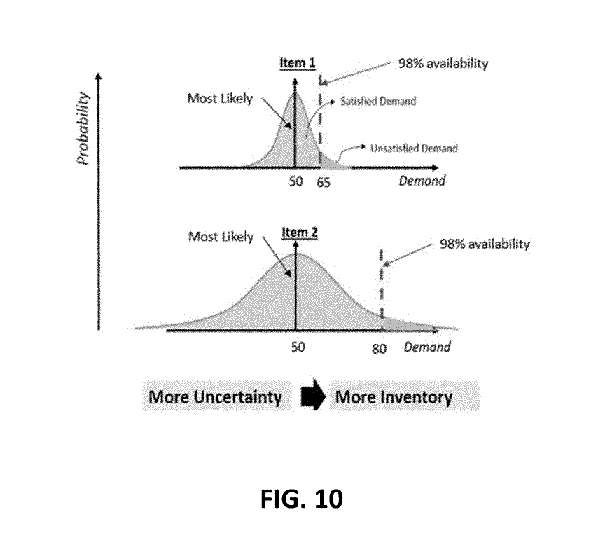

The demand probability distribution is an input to the inventory allocation engine 302 and represents the probabilities of many different possible rates of sale occurring. It is often represented as a histogram, as shown in the example of FIG. 9, where each bar represents the percentage chance of a certain number of sales units. The line represents an accumulation of each percentage units are added to the right. Probability distributions vary significantly in shape based on how an item sells (fast, slow, sells in multiples, short life, long life, etc.) and its historical sales variability. They also can look different day by day, and for the same day at different times of the year. It is the shape of these distributions and how they change over time that allow the system to account for the different types of business a retailer runs (referred to as push, pull, push/chase, limited time offer, etc.). Examples of demand distributions for two different items are displayed in FIG. 10.

The distribution shows what rate of sale is most likely to occur (about 4 units in the example of FIG. 9) and by extension the inventory that would be needed to support it. Based on the cumulative probability line however, carrying only 4 units would cause a missed sale for any demand higher than 4 which in the above demand distribution has a nearly 50% chance of occurring. To capture sales higher than the most likely, additional inventory must be carried. How much more is determined by the availability goal.

The availability goal effectively dictates what cumulative percent of possible sales values must be made possible. In the example of FIG. 9, there is a—55% chance of selling 4 units or less. Carrying 4 units would be the equivalent of a 55% availability goal. To be 90% available, 9 units must be held on the day represented by the distribution. By choosing to hold 9, the system forgoes the chance to sell 10 or 11. The availability goal is the largest controllable lever in determining the amount of inventory that is carried within a retail enterprise supply chain.

Returning to FIG. 6, at operation 604, direct costs are balanced with opportunity costs for each possible inventory position. Direct costs include costs of storing items in distribution centers and costs of transporting the items between nodes. Opportunity costs include loss of profits from lost sales due to an inability to fill an order within a needed timeframe. The cost analyzer 322 of the supply chain management system 200 analyzes and weigh these costs to determine if the costs of shipping and storing additional inventory are worth the benefit of making additional sales. This cost analysis is utilized to determine the best position for inventory within the supply chain.

At operation 606, customer availability goals are received for each of the retail and distribution locations. In some embodiments, customer availability goals are set by a user through the computing device 220 and are communicated to the inventory allocation engine 320. Customer availability goals may change depending on seasons or promotions. As discussed above, the goal can be set to control overall inventory strategies for a supply chain.

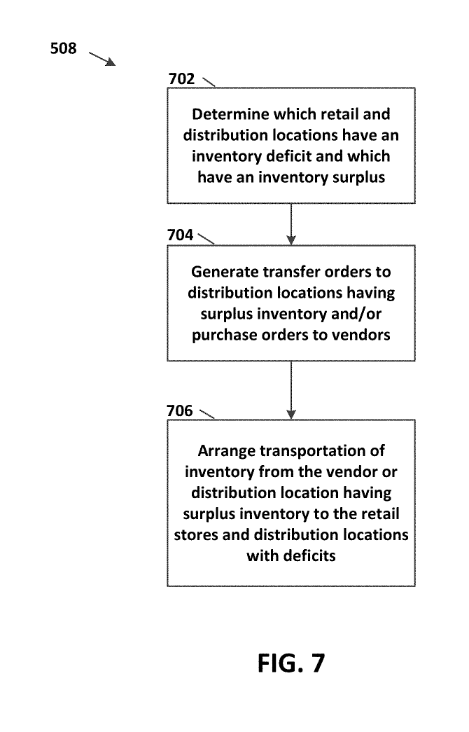

FIG. 7 illustrates an example method 508 of replenishing inventory to achieve optimized inventory positions. The replenishment management system 204 operates in conjunction with the inventory management system 202 to identify when and where inventory needs to be moved between nodes with a supply chain.

At operation 702, it is determined which retail locations and distribution locations have an inventory deficit and which have an inventory surplus. The inventory tracking engine 302 tracks the inventory levels at the plurality of retail and distribution locations and compares the current inventory levels with the optimized inventory positions determined by the inventory allocation engine 320. A location is determined to have a deficit when the number of units of a particular item are below the amount required by the optimized inventory position for that item in that location on that day. In some embodiments, a location is considered to have a surplus of an item if there are more units of that item than the optimized inventory position requires. In other embodiments, a location is considered to have a surplus of an item if it is determined that benefit of transferring one or more units of an item to another location will provide more benefits then detriments to the overall retail. The inventory tracking engine 302 determines in real-time which locations need replenishment.

At operation 704, transfer orders and/or purchase orders are generated. If there is surplus inventory available at one or more other nodes in the supply chain, the transfer order generator 304 issues transfer orders to those other nodes to transport units of the needed item to nodes experiencing an inventory deficit. If there is not surplus inventory available at other nodes in the supply chain or the cost analyzer 322 has determined that the cost of transferring inventory to the nodes having a deficit outweighs the cost of ordering new inventory, a purchase order is issued by the purchase order generator 306. The purchase order is communicated to the vendor that produces the required item, as well as to the transportation management system 206.

At operation 706, transportation of inventory is arranged. For purchase orders, the transportation management system 206 arranges transportation from the vendor to the location having an inventory deficit. For transfer orders, the transportation management system 206 arranges transportation from the distribution location having a surplus to the location having an inventory deficit.

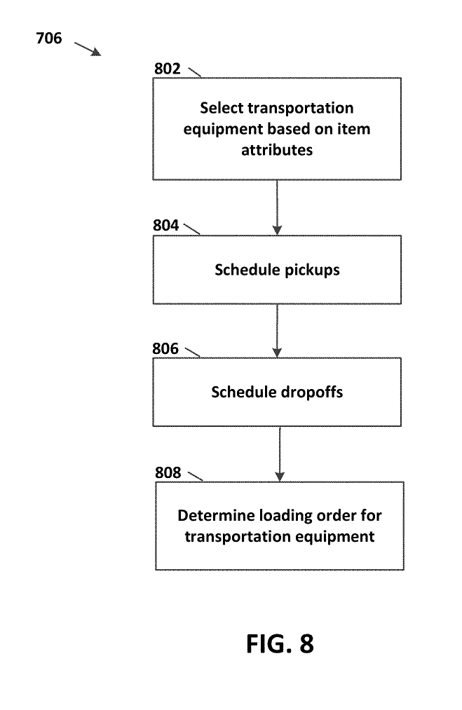

FIG. 8 illustrates an example method 706 of arranging transportation of inventory. The transportation management system 206 utilizes information in the item attribute database 310, transportation database 312, and warehouse database 315 to complete this task. Additionally, the transportation management system 206 works in conjunction with the warehouse management engine 308 to coordinate loading and unloading of transportation equipment at distribution locations. The transportation management system 206 will work with the inventory management system 202 to orchestrate the loading sequence of vessels onto a trailer to facilitate efficient multi-stops. Routes will be scheduled to coincide with normal shipping schedules as well as creating additional trips to ensure that need-by-times are met for particular items.

At operation 802, transportation equipment is selected based on the attributes of the items to be transported. The transportation management system 206 accesses the item attribute database 310 to determine the attributes of the items that are to be transported. Relevant attributes include item weight, item volume, whether the item is flammable, whether the item includes hazardous materials, and whether item requires storage at a particular temperature. Then, based on the attributes of the items, the transportation management system 206 selects equipment to transport the items. The transportation database 312 provides information about available transportation equipment, the capacity of the equipment, the type of storage available in the equipment, and the cost of operating the equipment.

At operation 804, pickups at one or more locations are scheduled. Pickups may occur at a vendor, a distribution location, or a retail location. The transportation management system 206 again relies on information stored in the transportation database 312 to schedule pickups. Delivery schedules, vendor pickup windows, and delivery windows are accessed from the transportation database 312. Pickups are scheduled at times when the inventory to be picked up is available for loading. Pick up times from nodes will also be scheduled based on a facility critical cut time or entry time, product need-by-time or promise, or a pre-scheduled move between nodes. Whenever possible, pickups of inventory will be combined with regular deliveries or with transportation to or from nearby nodes.

At operation 806, drop-offs at one or more locations are scheduled. Dropoffs may occur at a distribution location, a retail location, or at a customer address. Information in the transportation database 312 is utilized to schedule drop-offs. Dropoffs are scheduled at times when the delivery will be accepted at its destination. For distribution locations and retail locations, this may be when unloading can occur. Dropoffs are scheduled to arrive within the need-by time.

The transportation management system 206 will schedule a delivery time a receiving node and will provide updated time of arrival information as needed to stores and customers. Delivery options can be customized depending on the needs of the receiving node. Such needs may include optimizing the unloading process for daily deliveries, specialized services to support delivery to local inject hubs, and services specific to the needs of urban logistics. Urban logistics will require delivery equipment that is smaller and allows for curb-side unloads as well as unattended deliveries in which the driver moves the inventory into the store.

Finally, the transportation management system 206 will coordinate and schedule deliveries from nodes to customers. The goal is to provide the highest levels of speed, availability and assortment to the customers while remaining as cost effective as possible. The transportation management system will enable customers to pick up orders from any node or provide local delivery to customers. Delivery options will be optimized to increase efficiency and speed in delivering items to customers.

At operation 808, a loading order for the transportation equipment is determined based on the scheduled drop-offs. The transportation database 312 operates in conjunction with the warehouse management engine 308 to determine the best loading order for the transportation equipment based on the scheduled pickups and drop-offs. For example, if a trailer is being loaded at one distribution center for drop-offs at three different retail stores, the trailer will be loaded in the reverse order that the shipments will be made in order to facilitate unloading of the trailer.

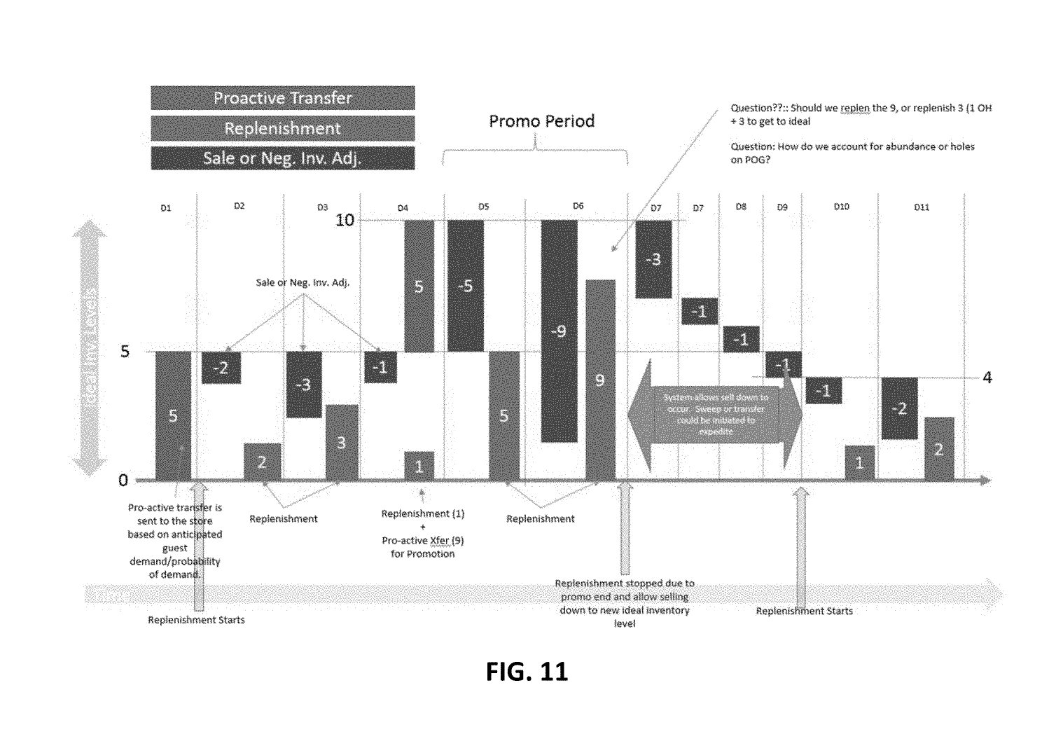

FIG. 11 is a graph illustrating the replenishment process described above. The vertical axis represents the optimized inventory levels or positions for a given store (in units) and the horizontal axis represents time given in days. In this example, the optimized inventory levels are modified for a promotion of a new item being offered for sale in the store.

At day 1, the initial demand probability forecast for the new item is determined, and the inventory allocation engine 320 has set the optimized inventory level to 5 units. Based on the optimized inventory level set by the inventory allocation engine 320, the proactive replenishment engine 316 issues instructions to the inventory management system 202 to transfer 5 units to the store. At this point, it is also determined that the upstream flow center for this store (not represented in the graph) needs 4 units of safety stock to support the future needs of the store. The inventory management system 202 also facilitates transfer of stock to the flow center to meet the optimized inventory levels determined by the inventory allocation engine 320.

Demand signals are received at the reactive replenishment engine 318 on day 2 in response to sales. In response to the sales of 2 units on day 2, the reactive replenishment engine 318 signals to the inventory management system 202 a request for 2 units. The transfer order generator 304 then issues a transfer order to move 2 units of the item from the flow center to the store. The same process is repeated on day 3 when 3 units are sold and 3 units are then replenished with a reactive transfer.

On day 4, the inventory allocation engine 320 receives notice that there will be an upcoming promotion on day 5 and calculates the optimized inventory level to be 10 units. A proactive transfer is triggered by the proactive replenishment engine 316 in order to position 10 units at the store by day 5. In addition, another unit was sold at the store, triggering a reactive transfer of an additional unit. Meanwhile, upstream the flow center is receiving additional stock from receive centers and vendors to maintain its needed inventory levels.

Promotional sales begin on day 5 and 1 to 1 replenishment continues in the form of reactive transfers through day 6.

On day 6, the inventory allocation engine 308 determines that the optimized inventory levels should be reduced in light of the end of the promotion. Reactive replenishment is paused to allow the inventory at the store to sell down to a new optimized inventory level of 4 units. The sell down process lasts until day 9, when the inventory level at the store reaches the optimized inventory level of 4 units.

1-to-1 reactive replenishment resumes on day 10 to maintain the optimized inventory level of 4 units at the store. Reactive transfers maintain the inventory level at 4 units through day 11.

Referring now to FIGS. 1-11 generally, it is noted that the methods and systems of the present application provide a number of computational and physical advantages when implemented in conjunction with a particular supply chain infrastructure. In particular, management of items at the item level rather than at the shipping unit level allows for more granular control over item shipments within an enterprise, thereby allowing for reduced storage levels at stores. Furthermore, by using optimized inventory levels, and predicted inventory levels throughout the supply chain, an enterprise may ensure products are “in flight” toward positions at which they can be delivered to a customer, either from an in-store sale from a shelf, or from a ship injection process. Furthermore, management of products at the item level allows for reconfiguration of products for shipment which can make restocking simpler at the store. Additionally, because of the reduced back room and shelf storage requirements that are realized due to improved prediction and tracking, additional SKUs can be presented to users on store shelves (since fewer of each item needs to be stocked on the shelf) and the additional back room area of stores can be used for other revenue-enhancing operations, such as managing direct-to-customer shipments of items not otherwise stocked at a store shelf. Other advantages are possible as well, consistent with the present disclosure.

Embodiments of the present invention, for example, are described above with reference to block diagrams and/or operational illustrations of methods, systems, and computer program products according to embodiments of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more embodiments provided in this application are not intended to limit or restrict the scope of the invention as claimed in any way. The embodiments, examples, and details provided in this application are considered sufficient to convey possession and enable others to make and use the best mode of claimed invention. The claimed invention should not be construed as being limited to any embodiment, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate embodiments falling within the spirit of the broader aspects of the general inventive concept embodied in this application that do not depart from the broader scope of the claimed invention.

1. A method of managing inventory replenishment in an enterprise supply chain including a plurality of retail locations and a plurality of distribution locations, the distribution locations including one or more bulk goods receipt locations and one or more intermediate item flow locations, the method comprising:
determining optimized inventory positions for each of a plurality of individual items at each of the plurality of retail locations and distribution locations based on at least a demand probability distribution for the plurality of items at each of the plurality of retail locations;
monitoring inventory positions of the plurality of items individually at each of the retail locations and distribution locations;
receiving demand signals from a point of sale network in communication with the plurality of retail locations and an online ordering system, the demand signals including sales events received from the point of sale network;
in response to the demand signals, replenishing inventory to achieve the optimized inventory positions for the plurality of items, where replenishing comprises:
determining, based on the monitoring, which retail locations and distribution locations have inventory deficits,
generating transfer orders to distribution locations having surplus inventory and/or purchase orders to vendors to fulfill the inventory deficits, and
arranging transportation of individual inventory items from the vendor or distribution location having surplus inventory to the retail locations and distribution locations having inventory deficits; and
recording the new inventory positions of each item in each location in an inventory data store.

2. The method of claim 1, wherein optimized inventory positions are further determined by balancing direct costs with opportunity costs.

3. The method of claim 1, wherein optimized inventory positions are further determined based on the customer availability goals for each of the retail and distribution locations.

4. The method of claim 1, wherein monitoring inventory positions of the plurality of items at each of the retail locations and distribution locations comprises receiving notifications when individual items leave or arrive at a retail or distribution location, and updating an inventory database with the current inventory positions of the plurality of items.

5. The method of claim 1, wherein a transfer order is generated for an item if the cost of transferring the item from another distribution location is less than the cost of ordering the item from a vendor.

6. The method of claim 5, wherein the costs include at least lost opportunity costs of having the item at the distribution location having a surplus, the cost of transporting the item, and the difference in cost for storing the item at the distribution location having a surplus versus the distribution location having a deficit.

7. The method of claim 1, wherein arranging transportation comprises:
selecting transportation equipment based on the attributes of the items to be transported;
scheduling pickups at one or more locations;
scheduling dropoff at one or more locations; and
determining a loading order for the transportation equipment based on the scheduled drop-offs.

8. The method of claim 1, wherein pickups and drop-offs are scheduled within a need-by timeframe.

9. The method of claim 1, further comprising calculating a stock unit for each item at each location, based on the demand probability distribution.

10. The method of claim 1, further comprising fulfilling online orders placed by customers by sending reactive demand signals to an inventory management system, arranging transportation of items requested in the online orders, and delivering the items to the customers.

11. The method of claim 3, further comprising receiving a request to modify the customer availability goals for one or more items at one or more locations and adjusting the optimized inventory positions for the one or more items at the one or more locations.

12. A system for managing supply chain operations in an enterprise including a plurality of retail locations and a plurality of distribution locations, the system comprising:
a replenishment management system comprising:
a computing system including a processor, and a memory communicatively coupled to the processor, the memory storing instructions executable by the processor to:
receive demand signals from one or more online ordering systems, point of sale systems, and/or demand forecast engines;
determine how much inventory to allocate to each of the retail locations and distribution locations;
generate inventory requests; and
an inventory management system comprising:
a computing system including a processor, and a memory communicatively coupled to the processor, the memory storing instructions executable by the processor to:
receive inventory requests;
monitor inventory levels at each of the retail locations and distribution locations;
generate purchase orders; and
generate transfer orders.

13. The system of claim 12, further comprising a transportation management system comprising:
a computing system including a processor, and a memory communicatively coupled to the processor, the memory storing instructions executable by the processor to:
select transportation equipment based on attributes of items to be transported;
schedule pickups of items from a first node;
schedule dropoffs of items at a second node; and
determine a loading order for the items in the selected transportation equipment.

14. The system of claim 12, further comprising an item attribute database, a transportation database, an inventory data store, and at least one warehouse database.

15. The system of claim 12, wherein the inventory management system generates transfer order and purchase orders in response to real-time demand signals received from a point of sale system or online ordering system.

16. The system of claim 12, wherein the demand signals include proactive demand signals and reactive demand signals.

17. The system of claim 12, wherein the inventory is used to replenish both in-store purchase and online orders.

18. The system of claim 12, wherein the inventory management system is further configured to determine a unit of measure in which to store each item in each location.

19. A non-transitory computer-readable storage medium comprising computer-executable instructions which, when executed by a computing system, cause the computing system to perform a method of managing inventory replenishment, the method comprising:
determining optimized inventory positions for each of a plurality of items at each of a plurality of retail locations and distribution locations within a supply chain based on at least one of a demand probability distribution for the plurality of items, balancing direct costs with opportunity costs, and customer availability goals;
monitoring inventory positions of the plurality of items at each of the retail locations and distribution locations;
receiving demand signals from a point of sale system in communication with the plurality of retail locations and an online ordering system, wherein the demand signals are sales;
in response to the demand signals, replenishing inventory to achieve the optimized inventory positions for the plurality of items, where replenishing comprises:
determining, based on the monitoring, which retail locations and distribution locations have an inventory deficit and which have an inventory surplus,
generating transfer orders to distribution locations having surplus inventory and/or purchase orders to vendors, and
arranging transportation of inventory from the vendor or distribution location having surplus inventory to the retail locations and distribution locations having deficits; and
recording the new inventory positions of each item in each location in an inventory data store.

20. The non-transitory computer-readable storage medium of claim 19, wherein the computing system is further configured to transport items to customers in fulfillment of online orders.
